(19) United States
(12) Patent Application Publication
(10) Pub. No.: US 2012/0113067 A1
(43) Pub. Date: May 10, 2012

(54) LCD PANEL AND A DRIVING METHOD THEREOF

(75) Inventor: Dengxia Zhao, Guangdong (CN)

(73) Assignee: SHENZHEN CHINA STAR OPTOELECTRONICS TECHNOLOGY CO., LTD., Shenzhen (CN)

(21) Appl. No.: 12/996,986

(22) PCT Filed: Nov. 10, 2010
(86) PCT No.: PCT/CN10/78617

§ 371 Date: Dec. 9, 2010

(51) Int. Cl. G09G 3/36; G09G 5/00

(52) U.S. Cl. 345/204; 345/87

(57) ABSTRACT

A liquid crystal display panel includes at least one pixel units. Each pixel unit includes a first storage capacitor electrically connected to a first transistor, a second storage capacitor electrically connected to a second transistor, and a charge-sharing capacitor having two ends electrically connected to the second storage capacitor and to an inverter. The electric potential of the charge-sharing capacitor changes because of an inverted scanning signal output by the inverter and further alters the stored voltage applied on the second storage capacitor after the scan line finishes transmitting the scanning signal, so that the first storage capacitor and the second storage capacitor have different voltages. Therefore, the color washout phenomenon is improved.

### BACKGROUND OF THE INVENTION

1. Field of the Invention

The present invention relates to a liquid crystal display (LCD) panel and a driving method thereof and more particularly, to an LCD panel which helps improve color washout and a driving method thereof.

2. Description of Prior Art

TFT-LCDs, having properties of high image quality, high space utilization efficiency, low consumption power, and no radiation, have gradually become the mainstream of the market. In order to meet current market requirements, TFT-LCDs tend to have the characteristics like high contrast ratios, high-speed response, and wide viewing angles. Technologies which can provide wide viewing angles nowadays include multi-domain vertically alignment (MVA), multi-domain horizontal alignment (MHA), twisted nematic plus wide viewing film (TN+film), and in-plane switching (IPS).

Although TFT-LCDs adopting MVA feature wide viewing angles, this kind of TFT-LCD has a well-known disadvantage—color washout. When users try to see display images at different watching angles, they will, however, find that images have different colors, which is called color washout. For instance, users will see whiter images when seeing images with a more slanted angle.

Ways to solve the above-mentioned color washout problem include adopting retardation films which are a combination of A-plate and C-plate, reducing cell gaps, and forming two LC capacitors inside a single pixel. However, the effect of compensation of retardation films formed by a combination of A-plate and C-plate is not obvious, and a reduction in cell gaps decreases yield rates and brightness. As for formation of two LC capacitors inside a single pixel, an additional dielectric layer is required, which usually causes some problems such as mura and residual images.

### SUMMARY OF THE INVENTION

The object of the present invention is to propose an LCD which utilizes charge-sharing capacitors to change pixel voltage in order to reduce the color washout phenomenon.

In one aspect of the present invention, a liquid crystal display panel comprises a plurality of data lines, a plurality of scan lines, and a plurality of pixel units, characterized in that the liquid crystal display panel further comprising: at least one inverter electrically connected to a corresponding scan line for inverting the scanning signal; each of the inverters corresponding to at least one of the pixel units; each of the pixel units further comprising: a first transistor and a second transistor electrically connected to a corresponding scan line for conducting the data signal when receiving the scanning signal; a first storage capacitor electrically connected to the first transistor; a second storage capacitor electrically connected to the second transistor; and a charge-sharing capacitor having two ends electrically connected to the second storage capacitor and to the inverter. After the scan line finishes transmitting the scanning signal, a change of an electric potential on the charge-sharing capacitor, resulting from an inverted scanning signal output by the inverter, alters the stored voltage applied on the second storage capacitor, so that the first storage capacitor and the second storage capacitor have different voltagesIn another aspect of the present invention, a liquid crystal display panel comprises a plurality of data lines, a plurality of scan lines, and a plurality of pixel units, characterized in that each of the pixel units further comprising: a first transistor and a second transistor electrically connected to a first scan line; a first storage capacitor electrically connected to the first transistor; a second storage capacitor electrically connected to the second transistor; and a charge-sharing capacitor having two ends electrically connected to the second storage capacitor and to a second scan line in the following row. The first transistor and the second transistor conduct the data signal to the first storage capacitor, the second storage capacitor, and the charge-sharing capacitor after the first scan line finishes transmitting a first scanning signal and the second scan line finishes transmitting a second scanning signal; when the first scan line does not transmit the first scanning signal and the second scan line finishes transmitting the second scanning signal, a change of an electric potential of the charge-sharing capacitor resulting from the second scanning signal alters the stored voltage applied on the second storage capacitor, so that the first storage capacitor and the second storage capacitor have different voltages.

According to the present invention, when the first scan line delivers first scanning signal and the second scan line does not deliver the second scanning signal, the first and second transistors pre-charge. In addition, a transmission of the first scanning signal from the first scan line is prior to that of the second scanning signal from the second scan line is enabled to transmit.

In yet another aspect of the present invention, a pixel unit comprises a first transistor and a second transistor electrically connected to a scan line, for conducting a data signal in response to a scanning signal, a first storage capacitor electrically connected to the first transistor, a second storage capacitor electrically connected to the second transistor, and a charge-sharing capacitor having two ends electrically connected to the second storage capacitor and to a driving signal. After the scan line transmits a scanning signal, a change of an electric potential of the charge-sharing capacitor, resulting from a change of the driving signal, alters the stored voltage applied on the second storage capacitor, so that voltages across the first storage capacitor and the second storage capacitor are different.

According to the present invention, the driving signal is a scanning signal from the next scan line.

According to the present invention, the driving signal is an inversion of the scanning signal.

According to the present invention, the first storage capacitor is electrically connected to the first transistor and a first sharing voltage end. The second storage capacitor is electrically connected to the second transistor and a second sharing voltage end. The first and the second sharing voltage end are used for supplying constant voltages, respectively. The constant voltages from the first sharing voltage end from the second sharing voltage end are identical.

As compared with the prior art, the pixel unit of the LCD panel of the present invention has a first storage capacitor, a second storage capacitor, and a charge-sharing capacitor. The two storage capacitors are electrically connected to two transistors, respectively. Two ends of the charge-sharing capacitor are electrically connected to the second storage capacitor and to a signal end with a different electric potential, respectively. When the pixel unit is activated, the charge-sharing capacitor causes the voltage of the first storage capacitor to be different from that of the second storage capacitor by means of the level of the signal end. Thus, LC molecules on the pixel unit can generate different inclination angles to solve the color washout problem of LCD screens.

These and other objects of the claimed invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an equivalent circuit diagram illustrating a pixel unit according to a first embodiment of the present invention.

FIG. 2 is a waveform diagram illustrating a scanning signal transmitted by the scan line and voltage applied on the charge-sharing capacitor.

FIG. 3 is an equivalent circuit diagram illustrating a pixel unit according to a second embodiment of the present invention.

FIG. 4 is a waveform diagram illustrating a scanning signal transmitted by the scan lines and voltage applied on the charge-sharing capacitor.

### DETAILED DESCRIPTION OF THE PREFERRED EMBODIMENTS

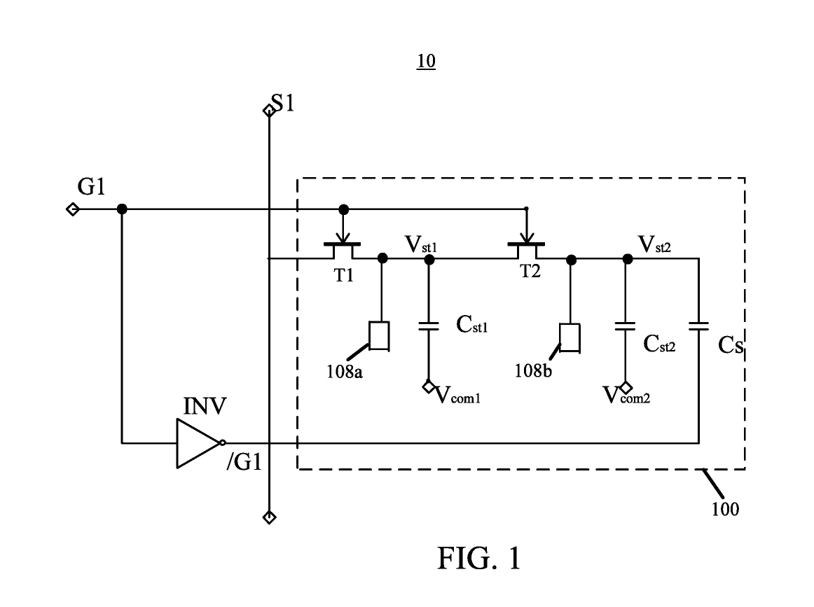

Referring to FIG. 1, FIG. 1 is an equivalent circuit diagram illustrating a pixel unit 100 according to a first embodiment of the present invention. An LCD panel 10 comprises a plurality of scan lines, a plurality of data lines, and a plurality of pixel units 100. To facilitate illustration and explanation, FIG. 1 simply illustrates a pixel unit 100, a scan line G1, and a data line S1. Both of the scan line G1 and the data line S1 are electrically connected to the pixel unit 100. The pixel unit 100 comprises a first thin film transistor T1, a second thin film transistor T2, a first pixel electrode 108a, a second pixel electrode 108b, a charge-sharing capacitor Cs, a first storage capacitor Cₛₜ₁, and a second storage capacitor Cₛₜ₂. The first thin film transistor T1 and the second thin film transistor T2 are electrically connected to the data line S1 and the scan line G1. And, the first pixel electrode 108a and the second pixel electrode 108b are electrically connected to the first thin film transistor T1 and the second thin film transistor T2, respectively. The first storage capacitor Cₛₜ₁ acts as a holding capacitor of the pixel unit 100 on one side, and the second storage capacitor Cₛₜ₂ acts as a holding capacitor of the pixel unit 100 on the other side. Two ends of the first storage capacitor Cₛₜ₁ are electrically connected to the first thin film transistor T1 and a first sharing voltage end V_{com1}. Two ends of the second storage capacitor Cₛₜ₂ are electrically connected to the second thin film transistor T2 and a second sharing voltage end V_{com2}. The two sharing voltage ends V_{com1}, V_{com2} are for supplying constant voltage. Preferably, the voltages from the two sharing voltage ends V_{com1}, V_{com2} are identical. The charge-sharing capacitor Cs is connected to the drain of the second thin film transistor T2 with the top electrode plate and to voltage of the scan line 104 inverted by an inverter INV, with the bottom electrode plate.

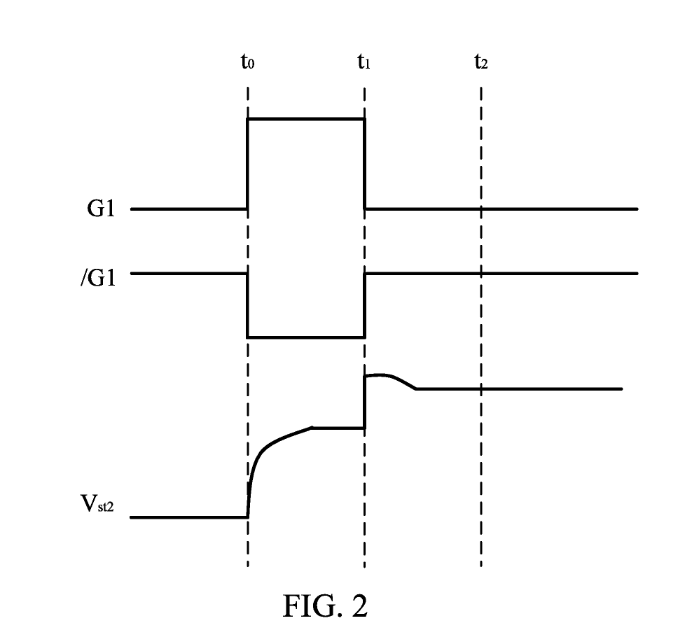

Referring to FIG. 1 and FIG. 2, FIG. 2 is a waveform diagram illustrating a scanning signal transmitted by the scan line G1 and voltage applied on the charge-sharing capacitor Cs. During the t₀-t₁ period, the scanning signal transmitted by the scan line G1 turns on the first thin film transistor T1 and the second thin film transistor T2. Afterwards, a data signal transmitted by the data line S1, passing through the first thin film transistor T1 and the second thin film transistor T2, is conducted to the first storage capacitor Cₛₜ₁, the second storage capacitor Cₛₜ₂, the charge-sharing capacitor Cs, the first pixel electrode 108a, and the second pixel electrode 108b. The first pixel electrode 108a and the second pixel electrode 108b adjust the moving direction of LC modules based on voltage applied on the data signal. Meanwhile, the first storage capacitor Cₛₜ₁, the second storage capacitor Cₛₜ₂, and the charge-sharing capacitor Cs store the voltage applied on the data signal, so that the voltage Vₛₜ₁ applied on the first storage capacitor Cₛₜ₁ and the voltage Vₛₜ₂ applied on the second storage capacitor Cₛₜ₂ are roughly the same. But the other one end of the charge-sharing capacitor Cs is electrically connected to the inverter INV, which outputs an inverted scanning signal, so the voltage across the charge-sharing capacitor Cs is different from that across the second storage capacitor Cₛₜ₂. During the t₁-t₂ period, the electrically connected charge-sharing capacitor Cs and second storage capacitor Cₛₜ₂ share the charge, which causes the voltage Vₛₜ₂ applied on the second storage capacitor Cₛₜ₂ to be altered. Accordingly, the voltage Vₛₜ₂ is different from the voltage Vₛₜ₁ applied on the first storage capacitor Cₛₜ₁. The first pixel electrode 108a and the second pixel electrode 108b determine angles of rotation of LC molecules based on voltages Vₛₜ₁ and Vₛₜ₂, so the color washout problem can be solved effectively based on different angles of rotation of the LC molecules. If the pixel unit 100 is decided to be applied to an MVA LCD, the pixel unit 100 can be designed to let the first and second storage capacitors Cₛₜ₁ and Cₛₜ₂ have two different voltages Vₛₜ₁ and Vₛₜ₂ by adjusting the capacity value of the charge-sharing capacitor Cs. Thus, the color washout problem can be solved.

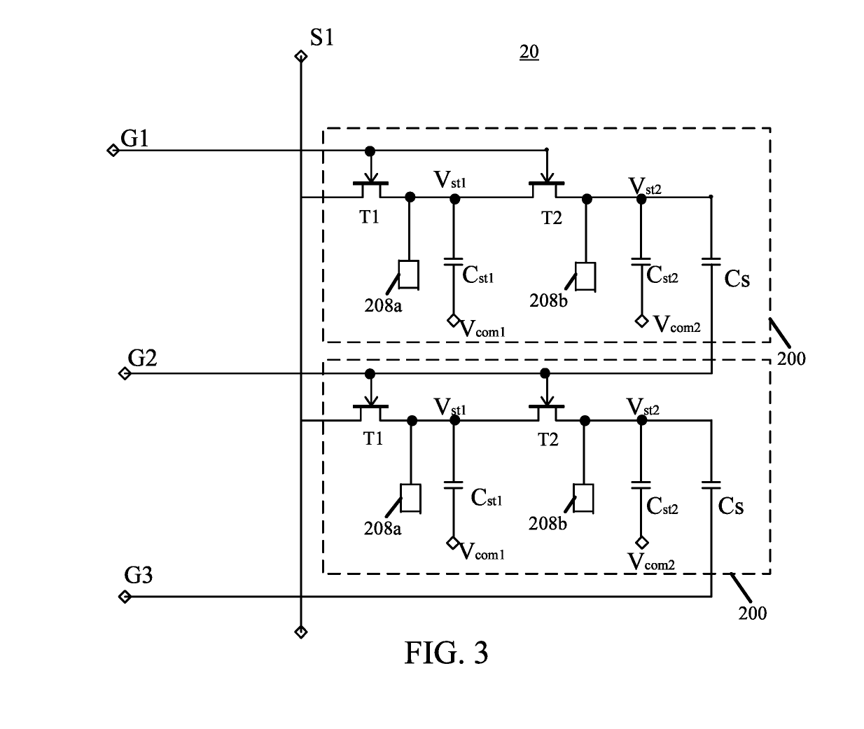

Referring to FIG. 3, FIG. 3 is an equivalent circuit diagram illustrating a pixel unit 200 according to a second embodiment of the present invention. An LCD panel 20 comprises a plurality of scan lines, a plurality of data lines, and a plurality of pixel units 200. To facilitate illustration and explanation, FIG. 3 simply illustrates two pixel units 200, scan lines G1, G2, and G3, and a data line S1. Both of the scan lines G1, G2, and G3, and the data line S1 are electrically connected to the pixel units 200. Each of the pixel units 200 comprises a first thin film transistor T1, a second thin film transistor T2, a first pixel electrode 208a, a second pixel electrode 208b, a charge-sharing capacitor Cs, a first storage capacitor Cₛₜ₁, and a second storage capacitor Cₛₜ₂. The first thin film transistor T1 and the second thin film transistor T2 are electrically connected to the data line S1 and the scan line G1. Besides, the first pixel electrode 208a and the second pixel electrode 208b are electrically connected to the first thin film transistor T1 and the second thin film transistor T2, respectively. The first storage capacitor Cₛₜ₁ acts as a holding capacitor on one side of the pixel unit 200, and the second storage capacitor Cₛₜ₂ acts as a holding capacitor on the other side. Two ends of the first storage capacitor Cₛₜ₁ are electrically connected to the first thin film transistor T1 and a first sharing voltage end V_{com1}; two ends of the second storage capacitor Cₛₜ₂ are electrically connected to the second thin film transistor T2 and a second sharing voltage end V_{com2}. The two sharing voltage ends V_{com1}, V_{com2} are for supplying constant voltage. Preferably, the voltages from the two sharing voltage ends V_{com1}, V_{com2} are identical. Two ends of the charge-sharing capacitor Cs are electrically connected to the scan line G2 and the second storage capacitor Cₛₜ₂, respectively.

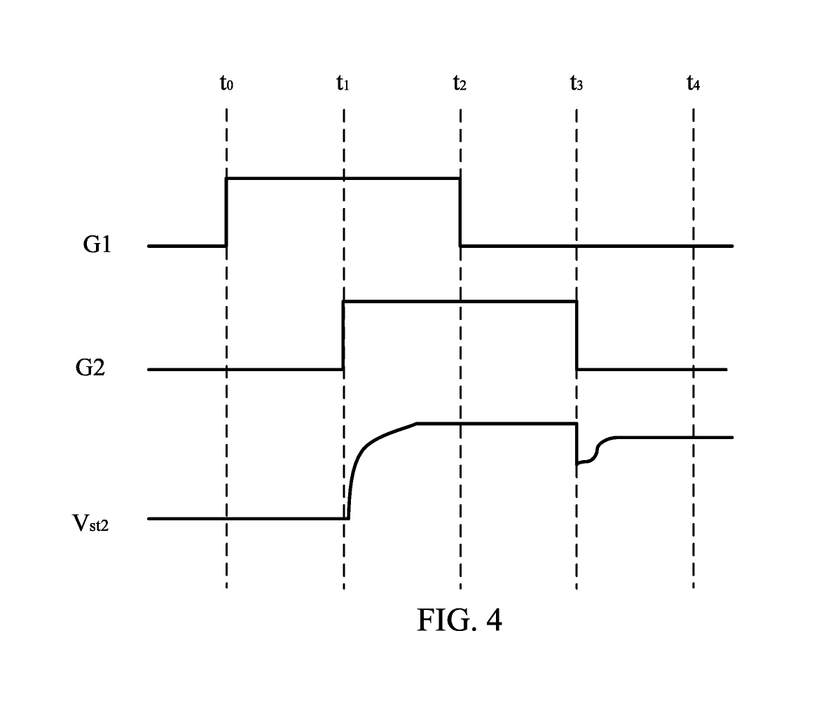

Referring to FIG. 3 and FIG. 4, FIG. 4 is a waveform diagram illustrating a scanning signal transmitted by the scan lines G1 and G2 and voltage applied on the charge-sharing capacitor Cs. At first, the scan line G1 emits a scanning signal in advance during the t₀-t₁ period to turn on the first thin film transistor T1 and the second thin film transistor T2, so that the first thin film transistor T1 and the second thin film transistor T2 can achieve pre-charge before the data signal is conducted.

Next, the scanning signal of the scan line G1 continues activating the first thin film transistor T1 and the second thin film transistor T2 during the t₁-t₂ period. The first and second thin film transistors T1 and T2 have been activated for a period of time, so they are completely activated during the t₁-t₂ period. Thus, the data signal transmitted from the data line S1 can be conducted to the first storage capacitor Cₛₜ₁, the second storage capacitor Cₛₜ₂, the charge-sharing capacitor Cs, the first pixel electrode 208a, and a second pixel electrode 208b after passing through the first thin film transistor T1 and the second thin film transistor T2 completely. The first pixel electrode 208a and the second pixel electrode 208b adjust the moving direction of LC modules based on the voltage of the data signal. Meanwhile, the first storage capacitor Cₛₜ₁, the second storage capacitor Cₛₜ₂, and the charge-sharing capacitor Cs store the voltage of the data signal, so the voltage Vₛₜ₁ of the first storage capacitor Cₛₜ₁ and the voltage Vₛₜ₂ of the second storage capacitor Cₛₜ₂ are roughly the same. At this time, the scan line G2 also emits the scanning signal to prompt the first thin film transistor T1 and the second thin film transistor T2 of the pixel unit 200 in the following row to enter a pre-charge status.

During the t₂-t₃ period, the other end of the charge-sharing capacitor Cs is electrically connected to the scan line G2. The scan line G2 continues outputting a scanning signal while the scan line G1 does not output any scanning signal at this period. At this time, the pixel electrodes 208a and 208b can remain the same for grayscale output based on the voltage stored by the first and second storage capacitors Cₛₜ₁ and Cₛₜ₂.

During the t₃-t₄ period, the scan line G2 does not transmit any pulse of the scanning signal. The scanning signal without any pulse is served as a driving signal fed to the charge-sharing capacitor Cs, so the voltage across the charge-sharing capacitor Cs is different from that across the second storage capacitor Cₛₜ₂. During this period, the electrically connected charge-sharing capacitor Cs and second storage capacitor Cₛₜ₂ share the charge, which causes the voltage Vₛₜ₂ applied on the second storage capacitor Cₛₜ₂ to be altered. Accordingly, the voltage Vₛₜ₂ is different from the voltage Vₛₜ₁ applied on the first storage capacitor Cₛₜ₁ The first pixel electrode 208a and the second pixel electrode 208b determine angles of rotation of LC molecules based on voltages Vₛₜ₁ and Vₛₜ₂, so the color washout problem can be effectively solved based on different angles of rotation of the LC molecules. If the pixel unit 200 is decided to be applied to an MVA LCD, the pixel unit 200 can be designed to let the first and second storage capacitors Cₛₜ₁ and Cₛₜ₂ have two different voltages Vₛₜ₁ and Vₛₜ₂ by adjusting the capacity value of the charge-sharing capacitor Cs. Thus, the color washout problem can be solved.

Although the present invention has been explained by the embodiments shown in the drawings described above, it should be understood to the ordinary skilled person in the art that the invention is not limited to the embodiments, but rather various changes or modifications thereof are possible without departing from the spirit of the invention. Accordingly, the scope of the invention shall be determined only by the appended claims and their equivalents.

What is claimed is:

1. A liquid crystal display panel comprising a plurality of data lines, a plurality of scan lines, and a plurality of pixel units, characterized in that the liquid crystal display panel further comprising: at least one inverter electrically connected to a corresponding scan line for inverting the scanning signal; each of the inverters corresponding to at least one of the pixel units; each of the pixel units further comprising:
a first transistor and a second transistor electrically connected to a corresponding scan line for conducting the data signal when receiving the scanning signal;
a first storage capacitor electrically connected to the first transistor;
a second storage capacitor electrically connected to the second transistor; and
a charge-sharing capacitor having two ends electrically connected to the second storage capacitor and to the inverter;
wherein after the scan line finishes transmitting the scanning signal, a change of an electric potential on the charge-sharing capacitor, resulting from an inverted scanning signal output by the inverter, alters the stored voltage applied on the second storage capacitor, so that the first storage capacitor and the second storage capacitor have different voltages.

2. The liquid crystal display panel of claim 1, characterized in that the first storage capacitor is electrically connected the first transistor and a first sharing voltage end.

3. The liquid crystal display panel of claim 2, characterized in that the second storage capacitor is electrically connected the second transistor and a second sharing voltage end.

4. The liquid crystal display panel of claim 3, characterized in that the first and the second sharing voltage end are used for supplying constant voltages, respectively.

5. The liquid crystal display panel of claim 3 or 4, characterized in that the constant voltages from the first sharing voltage end for the second sharing voltage end are identical.

6. A liquid crystal display panel comprising a plurality of data lines, a plurality of scan lines, and a plurality of pixel units, characterized in that each of the pixel units further comprising:
a first transistor and a second transistor electrically connected to a first scan line;
a first storage capacitor electrically connected to the first transistor;
a second storage capacitor electrically connected to the second transistor; and
a charge-sharing capacitor having two ends electrically connected to the second storage capacitor and to a second scan line in the following row;
wherein after the first scan line finishes transmitting a first scanning signal and the second scan line finishes transmitting a second scanning signal, the first transistor and the second transistor conduct the data signal to the first storage capacitor, the second storage capacitor, and the charge-sharing capacitor; when the first scan line does not transmit the first scanning signal and the second scan line finishes transmitting the second scanning signal, a change of an electric potential of the charge-sharing capacitor resulting from a change of the second scanning signal alters the stored voltage applied on the second storage capacitor, so that the first storage capacitor and the second storage capacitor have different voltages.

7. The liquid crystal display panel of claim 6, characterized in that a transmission of the first scanning signal from the first scan line is prior to that of the second scanning signal from the second scan line.

8. The liquid crystal display panel of claim 6, characterized in that the first storage capacitor is electrically connected to the first transistor and a first sharing voltage end.

9. The liquid crystal display panel of claim 8, characterized in that the second storage capacitor is electrically connected to the second transistor and a second sharing voltage end.

10. The liquid crystal display panel of claim 9, characterized in that the first and the second sharing voltage end are used for supplying constant voltages, respectively.

11. The liquid crystal display panel of claim 9 or 10, characterized in that the constant voltages from the first sharing voltage end from the second sharing voltage end are identical.

12. A pixel unit comprising:
a first transistor and a second transistor electrically connected to a scan line, for conducting a data signal in response to a scanning signal;
a first storage capacitor electrically connected to the first transistor;
a second storage capacitor electrically connected to the second transistor; and
a charge-sharing capacitor having two ends electrically connected to the second storage capacitor and to a driving signal;
wherein after the scan line transmits a scanning signal, a change of an electric potential of the charge-sharing capacitor, resulting from a change of the driving signal, alters the stored voltage applied on the second storage capacitor, so that voltages across the first storage capacitor and the second storage capacitor are different.

13. The pixel unit of claim 12, characterized in that the driving signal is a scanning signal from the next scan line.

14. The pixel unit of claim 12, characterized in that the driving signal is an inversion of the scanning signal.

15. The pixel unit of claim 12, characterized in that the first storage capacitor is electrically connected to the first transistor and a first sharing voltage end.

16. The pixel unit of claim 15, characterized in that the second storage capacitor is electrically connected to the second transistor and a second sharing voltage end.

17. The pixel unit of claim 16, characterized in that the first and the second sharing voltage end are used for supplying constant voltages, respectively.

18. The pixel unit of claim 16 or 17, characterized in that the constant voltages from the first sharing voltage end from the second sharing voltage end are identical.
